(19) United States
(12) Patent Application Publication
(10) Pub. No.: US 2018/0339403 A1
(43) Pub. Date: Nov. 29, 2018

(54) RATCHET WRENCH

(71) Applicant: Chia-Yu CHEN, Taichung City (TW)

(72) Inventor: Chia-Yu CHEN, Taichung City (TW)

(21) Appl. No.: 15/795,105

(22) Filed: Oct. 26, 2017

(30) Foreign Application Priority Data
May 25, 2017 (TW) 106117469

(51) Int. Cl. B25B 13/46

(52) U.S. Cl. CPC B25B 13/463

(57) ABSTRACT

The present invention relates to a ratchet wrench which comprises a head portion having an installation chamber for a ratchet gear, a control chamber for a switching unit, a control chamber for a switching unit and a ratchet chamber for a ratchet block. The ratchet chamber is formed in between the installation chamber and the control chamber. The ratchet wrench further comprises a base plate having a limit member chamber formed thereon and having a first limit wall and a second limit wall. There is a limit member installed in the control chamber and has a push portion formed thereon. The characteristic feature of the ratchet wrench is that the switching unit having a push portion formed thereon to match with the first limit wall or the second limit wall of the limit member chamber.

### BACKGROUND OF THE INVENTION

### Field of the Invention

The present invention relates a wrench particularly relates to a ratchet wrench.

### Brief Description of the Prior Art

A conventional ratchet wrench can be seen and understood from FIGS. 1 to 3 which show a perspective view, an exploded view and a sectional view of the ratchet wrench respectively.

Referring to FIGS. 1 and 2, the conventional ratchet wrench comprises a head portion 1 having a recess 2 in a circular sector shape formed on top surface of the head portion 1. The head portion 1 has a chamber formed therein for the installation of a ratchet 3, a tooth plate 4 and a switch member 5 which further comprises a slot formed to receive an elastic 7 and a pin 8. The switch member 5 has a handle 6 formed on the top portion thereof and to be rested in the recess 2 of the head portion 1. A seal plate 9 is provided to seal the chamber of the head portion 1 after the ratchet 3, tooth plate 4 and switch member 5 have been installed to complete the structure of the wrench.

The operation of the conventional ratchet wrench can be understood from FIG. 3 which shows a sectional view of the same. The handle 6 of the switch member 5 is operated to make the pin 8, being biased by the elastic 7, touching against the back of the tooth plate 4. One side wall of the tooth plate 4 is touching and against the inner wall A of the chamber in the head portion 1. With the switch member 5 being operated in this position, the wrench can be operated to work on a work piece such as a nut in one rotation direction.

In a similar way of operation with the handle 6 of the switch member 5 to make the pin 8 touching and against another side of the tooth plate 4, the other side wall of the tooth plate 4 will be touching and against the inner wall B of the chamber in the head portion 1. The wrench can be operated to work on a work piece in an opposite direction of rotation.

Apparently, one can see the difficulty in manufacturing such a conventional ratchet wrench particularly in cutting a recess 2 to form into a circular sector on the top surface of the head portion 1 of the ratchet wrench. Another disadvantage of the conventional ratchet wrench is a loose structure in the chamber of the head portion.

Another disadvantage of this conventional ratchet wrench is the control of rotation direction may be difficult and even lost. Because there is no secure mechanism to keep the pin 8 steadily in touch with the tooth plate 4, the operation of the handle 6 in turn to make the pin 8 against the back of the tooth plate 4 is not firm and accurate.

### SUMMARY OF THE INVENTION

It is therefore the primary object of the present invention being to provide a ratchet wrench having a head portion which is integral in its structure without a need to shape a recess for the installation of a handle to operate the ratchet mechanism.

Another object of the present invention is to provide a ratchet wrench which has a securing mechanism to make sure the ratchet gear will be tightly engaged with the ratchet block to maintain a steady contact so that the rotation direction will not be infected during operation of the wrench.

An essential feature of the ratchet wrench according to the present Invention is to provide a limit member formed on a base plate of the wrench. The limit member is installed in a control chamber to cause the same to maintain a steady contact between the ratchet gear and the ratchet block.

Therefore, a ratchet wrench according to the present invention comprises a head portion having an installation chamber for a ratchet gear, a control chamber for a switching unit and a ratchet chamber for a ratchet block. The ratchet chamber is formed in between the installation chamber and the control chamber. A base plate having a limit member chamber formed therein with a first limit wall and a second limit wall and a limit member installed in the control chamber having a push portion formed thereon. The switching unit has a push portion formed thereon and matches the first limit wall or second limit wall of the limit member chamber.

### BRIEF DESCRIPTION OF THE DRAWINGS

Those and other objects, advantages and features of the ratchet wrench according to the present invention can be understood from the below detailed description of the preferred embodiments with reference to the accompanying drawings, wherein:

FIG. 1 is a perspective view of a conventional ratchet wrench;

FIG. 2 is an exploded view of a conventional ratchet wrench;

FIG. 3 is a sectional view of a conventional ratchet wrench;

FIG. 4 is a perspective view of a first embodiment of a ratchet wrench according to the present invention;

FIG. 5 is an exploded view of a first embodiment of a ratchet wrench according to the present invention;

FIG. 6 is another exploded view, looking from an opposite direction, of a first embodiment of a ratchet wrench according to the present invention;

FIG. 7 is a partial sectional view of a first embodiment of a ratchet wrench according to the present invention;

FIG. 8 is an elevation from the bottom, with the base plate removed, of a first embodiment of a ratchet wrench according to the present invention;

FIG. 9 is an illustrative view of a first embodiment of a ratchet wrench when the switch handle being operated to a first position;

FIG. 10 is an illustrative view of a first embodiment of a ratchet wrench when the switch handle being operated to a first position and also limit member being operated to a first position;

FIG. 11 is an illustrative view of a first embodiment of a ratchet wrench when the switch handle being operated to a second position;

FIG. 12 is an illustrative view of a first embodiment of a ratchet wrench when the switch handle being operated to a second position and also limit member being operated to a second position;

FIG. 13 is an illustrative view of a switching unit of a second embodiment of a ratchet wrench according to the present invention; and

FIG. 14 is an illustrative view of a switching unit of a third embodiment of a ratchet wrench according to the present invention.

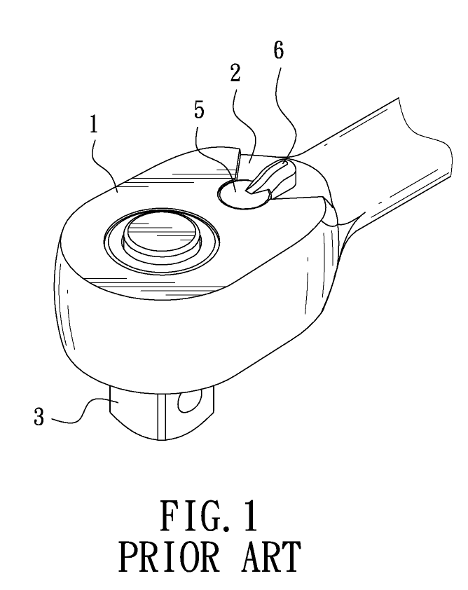

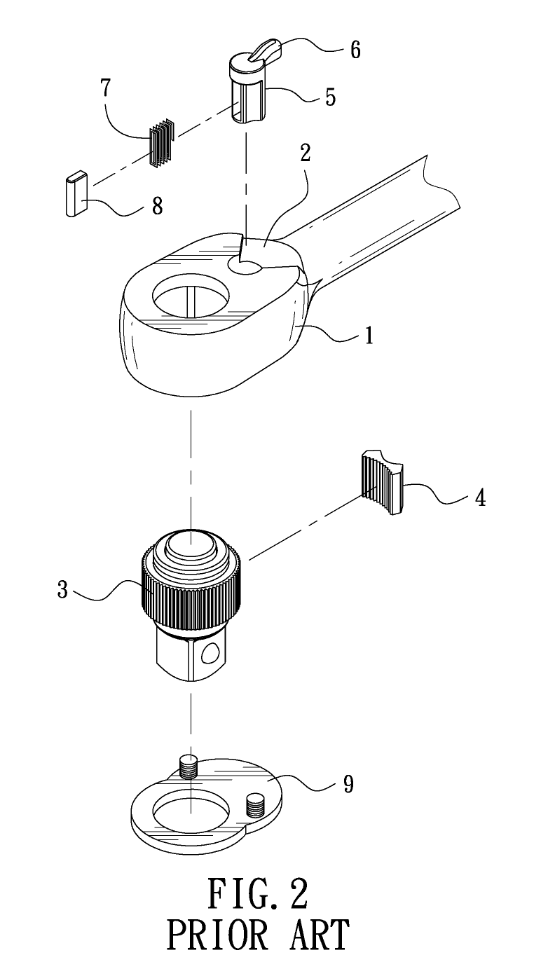

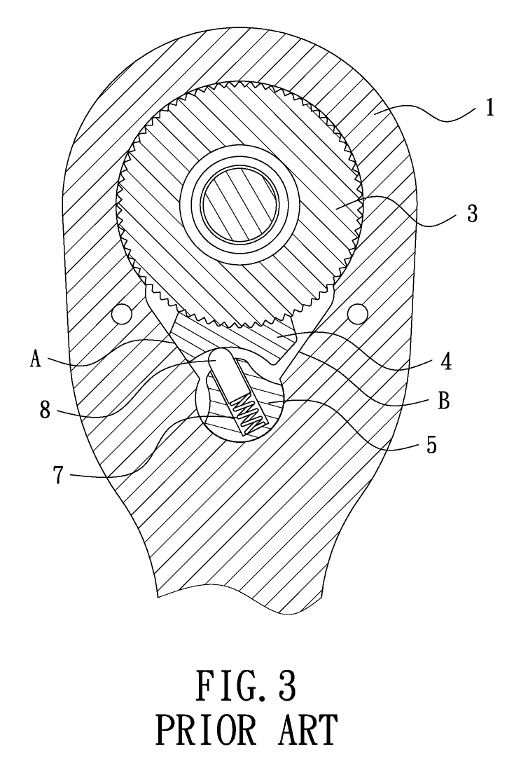

### DETAILED DESCRIPTION OF THE PREFERRED EMBODIMENT OF THE INVENTION

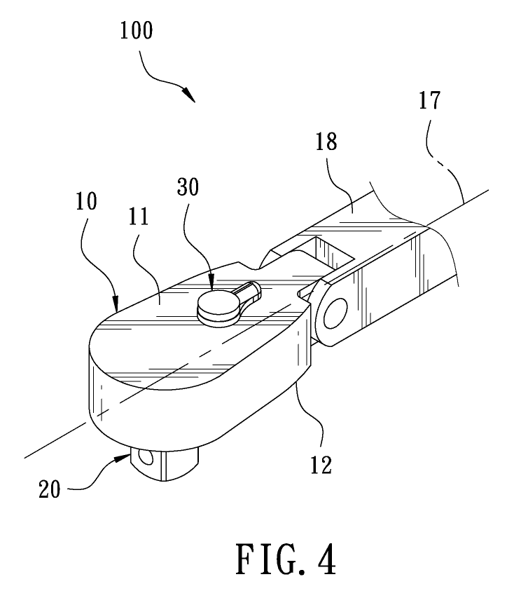

Referring to FIGS. 4 to 8, a first embodiment of a ratchet wrench according to the present invention shall be disclosed and described in detail. The various members for the overall structure of a ratchet wrench shall be shown in these figures.

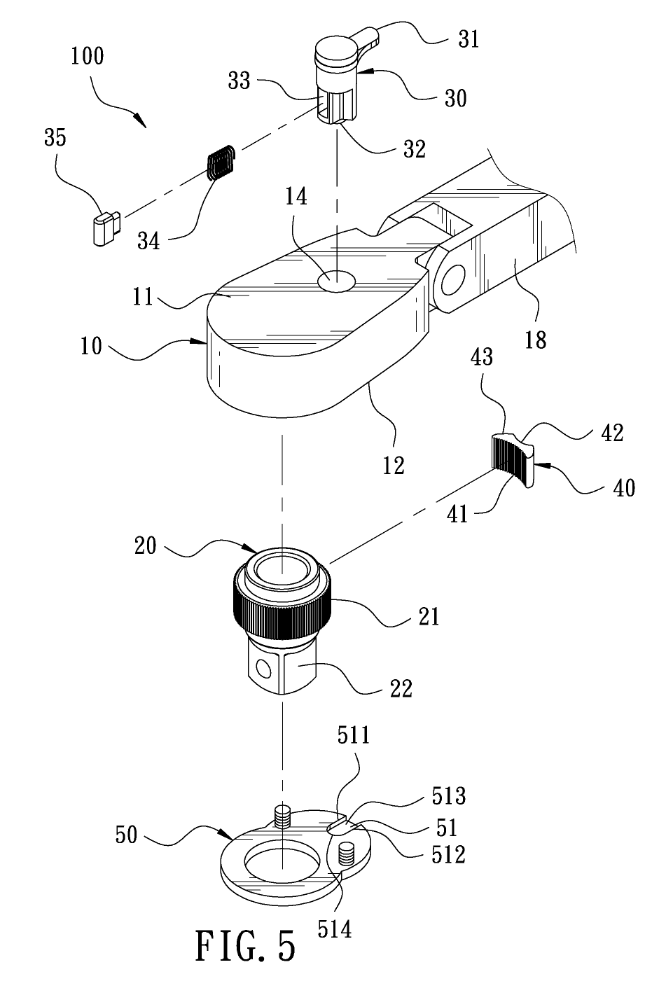

Referring particularly to FIGS. 4 and 5 which show perspective and exploded views of a ratchet wrench according to the present invention, the ratchet wrench 100 comprises a head 10 having a top surface 11 and a bottom surface 12. From the bottom surface 12, the head 10 comprises an installation chamber 13 which is substantially in a cone shape with an axle perpendicular to the bottom surface 12.

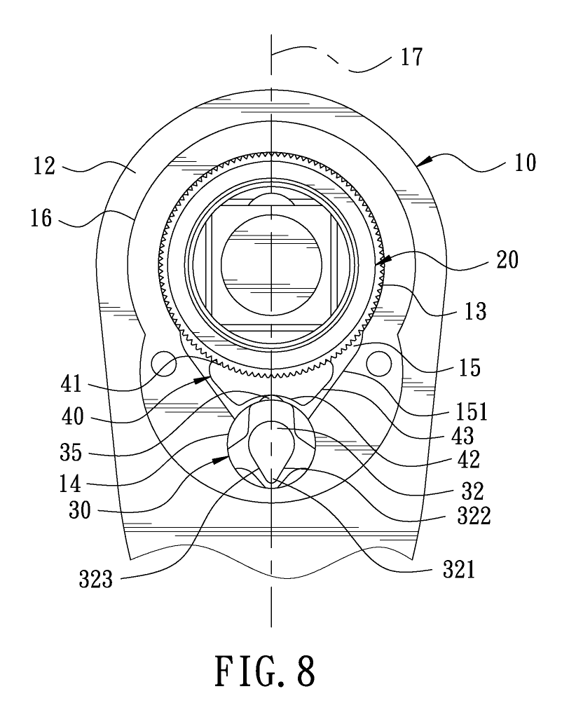

The head 10 also comprises a control chamber 14 from the bottom surface 12 and protruding outwardly through the top surface 11. The control chamber 14 has an axle parallel to the same of the installation chamber 13. In between the installation chamber 13 and the control chamber 14, there formed a ratchet chamber 15. Particularly refer to FIG. 8, there is a peripheral slot 16 at the bottom surface 12. The ratchet chamber 15 has push sections 151 at the inner wall of the ratchet chamber 15. The head 10 comprises a handle 18 for a user to operate the ratchet wrench against a workpiece. The wrench is structured having an axle 17 along the head 10 to the handle 18.

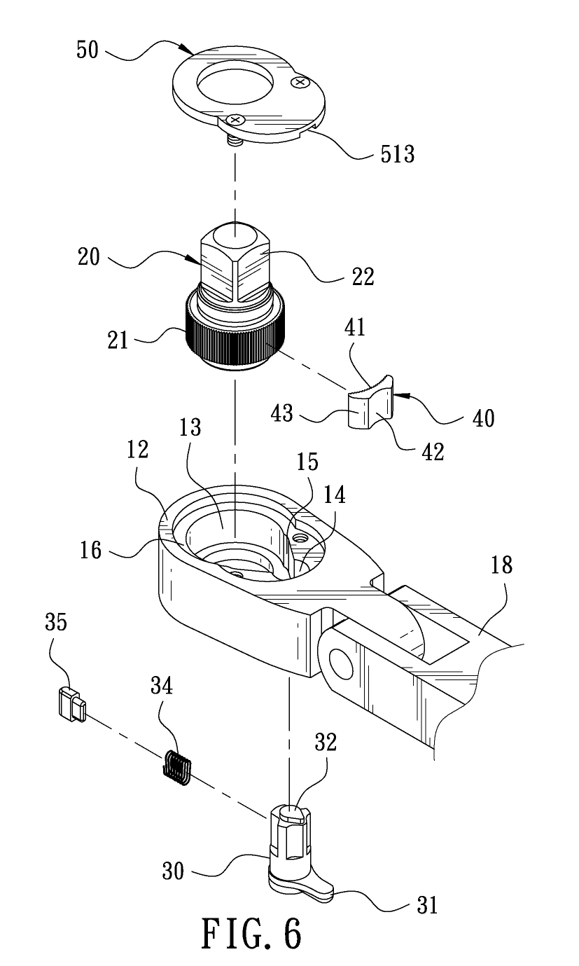

Referring to FIGS. 5 and 6 which show exploded views, from top and bottom respectively, of the ratchet wrench according to the present invention, A ratchet gear 20 is installed in the installation chamber 13 and comprises a plurality of ratchet teeth 21. In the middle of the ratchet gear 20, there is formed an adaptor 22 to be engaged with a workpiece.

A switching unit 30 is installed in the control chamber 14. The switching unit 30 comprises a handle 31 on top of the same and a limit member 32 formed along the axis direction of the switching unit 30. At one side of the ratchet chamber 15, there are formed limit member chamber 33 for the installation of an elastic 34 and a bias member 35. Particularly referring to FIG. 8, the limit member 32 is shaped with a push portion 321 and a pair of first limit surface 322 and second limit surface 323.

A ratchet 40 is installed in the ratchet chamber 15 and comprises a plurality of ratchet teeth 41 facing and engaging with the ratchet teeth 21 of the ratchet gear 20. The ratchet 40 is shaped with a arch ratchet wall 42 to be pushed by the bias member 35 of the switching unit 30. The ratchet 40 has a limit section 43 to be engages with the push sections 151 of the ratchet chamber 15.

Referring to FIG. 5, the ratchet wrench 100 comprises a base plate 50 to be covered from the bottom surface 12 of in the peripheral slot 16 of the head 10 with a plurality of screws. Corresponding to the switching unit 30, the base plate 50 is formed with a limit slot 51 having a pair of first limit wall 511, a second limit wall 512, a recess 513 and an arch 514.

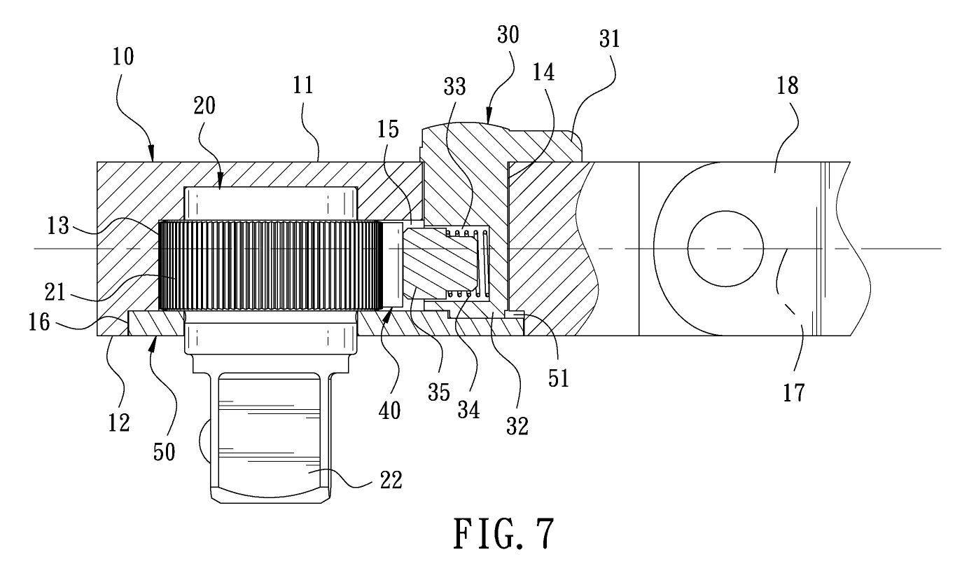

Referring to FIGS. 7 and 8 which show a sectional view and a bottom view of the head 10 portion, the switching unit 30 of the ratchet wrench 100 is operated to have the bias member 35, pushed by the elastic 34, to engage the ratchet wall 42 of the ratchet 40. The limit section 43 is pushed against the push section 151 in the ratchet chamber 15 causing the ratchet teeth 41 of the ratchet 40 to match with the ratchet teeth 21 of the ratchet gear 20. Depending on the control of the switch handle 31 of the switching unit 30, the bias member 35 can be moved to engage with the other side of the ratchet wall 42. Therefore, the ratchet gear 20 is controlled to be free to rotate in a different direction.

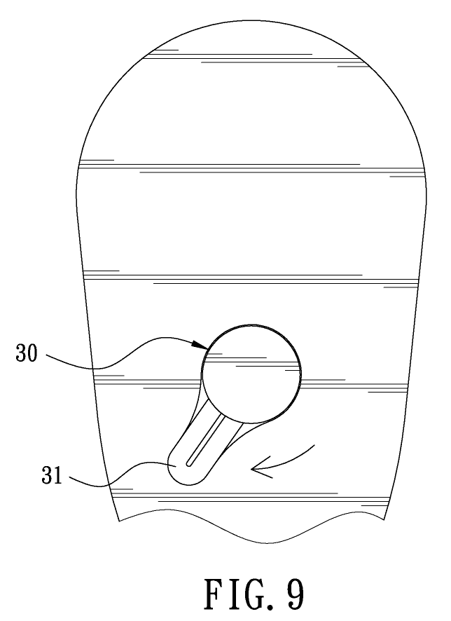

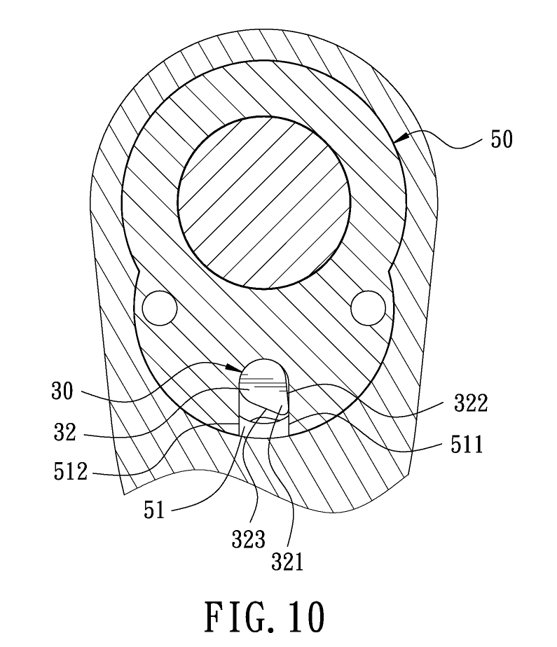

For a better understanding of the switch of rotation direction, please refer to FIGS. 9 and 10 which illustrative views of a first embodiment of a ratchet wrench when the switch handle being operated to a first position and also limit member being operated to a first position, the switch handle 31 of the switching unit 30 is operated clockwise to a first position as the arrow shows in FIG. 9. The push portion 321 of the limit member 32 will be against the first limit wall 511 of the limit slot 51. The first limit surface 322 will be matched with the first limit wall 511. At this time, the bias member 35 will push against tightly with the ratchet 40. The switch handle 31 will be blocked at this position and the ratchet wrench can be used to rotate a workpiece clockwise.

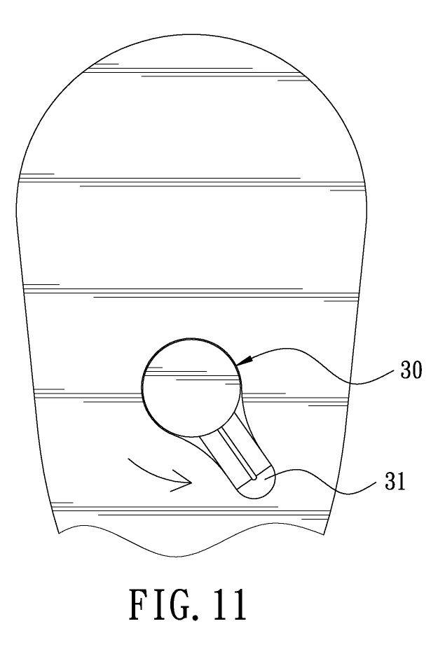

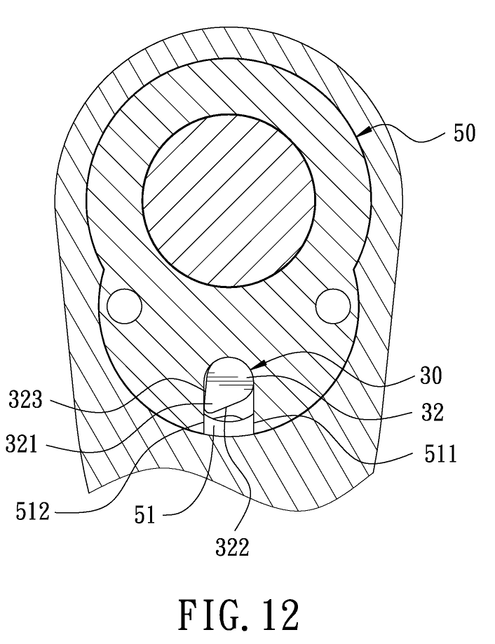

Referring to FIGS. 11 and 12 which illustrative views of a first embodiment of a ratchet wrench when the switch handle being operated to a second position and also limit member being operated to a second position, the switch handle 31 of the switching unit 30 is operated counter clockwise to a second position as the arrow shows in FIG. 11. The push portion 321 of the limit member 32 will be against the second limit wall 512 of the limit slot 51. The second limit surface 323 will be matched with the second limit wall 512. At this time, the bias member 35 will push against tightly with the ratchet 40. The switch handle 31 will be blocked at this position and the ratchet wrench can be used to rotate a workpiece counter clockwise.

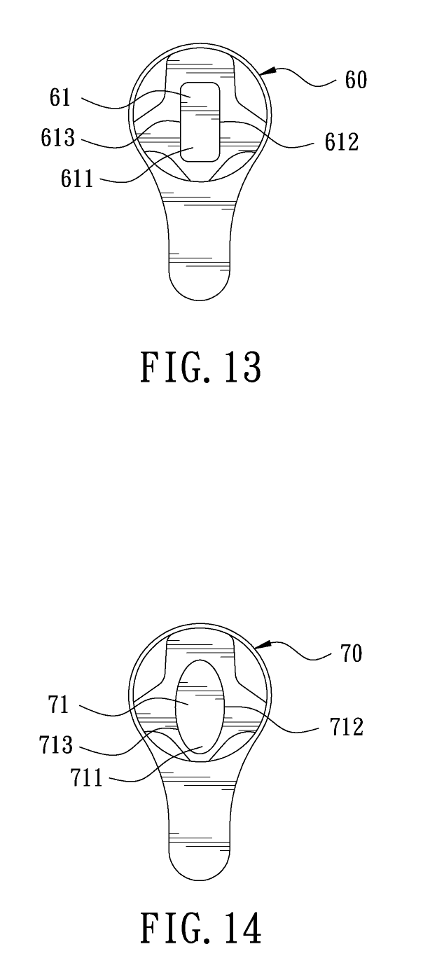

Referring to FIG. 13 which is an illustrative view of a switching unit of a second embodiment of a ratchet wrench according to the present invention, the limit member 61 of the switching unit 60 is in a shape of rectangular. The limit member 61 has a push member 611 and a pair of first limit surface 612 and a second limit surface 613. The first limit surface 612 can engage with the first limit wall 511 of the base plate 50 and the second limit surface 613 can engage with the second limit wall 512 of the base plate 50. The switch handle 31 will be steadily retained at a position during either clockwise or counter clockwise rotation of the ratchet wrench.

Referring to FIG. 14 which is an illustrative view of a switching unit of a third embodiment of a ratchet wrench according to the present invention, the limit member 71 of the switching unit 70 is in a shape of oval. The limit member 71 has a push member 711 and a pair of first limit surface 712 and a second limit surface 713. The first limit surface 712 can engage with the first limit wall 511 of the base plate 50 and the second limit surface 713 can engage with the second limit wall 512 of the base plate 50. The switch handle 31 will be steadily retained at a position during either clockwise or counter clockwise rotation of the ratchet wrench.

Although the ratchet wrench according to the present invention has been described by way of preferred embodiments, other changes, amendments and modifications can still be made without departing from the spirit of the invention and shall be fallen in the protection scope in the claims.

What is claimed is:

1. A ratchet wrench comprising,
a head portion having an installation chamber for a ratchet gear, a control chamber for a switching unit and a ratchet chamber for a ratchet block, said ratchet chamber being in between of said installation chamber and said control chamber;
a base plate having a limit member chamber formed thereon, said limit member chamber having a first limit wall and a second limit wall; and
a limit member installed in said control chamber and having a push portion formed thereon;
characterized in said switching unit having a push portion formed thereon and matching with said first limit wall or said second limit wall of said limit member chamber.

2. A ratchet wrench as claimed in claim 1 wherein said limit member chamber is shaped with a recess communicating with said ratchet chamber and an arch.

3. A ratchet wrench as claimed in claim 2 wherein said push portion of said limit member is formed in an arch shape to match said arch of said limit member chamber.

4. A ratchet wrench as claimed in claim 1 wherein said switching unit further comprising a switch handle to be operated to cause said switching unit to a first position or a second position.

5. A ratchet wrench as claimed in claim 4 wherein said limit member comprising a first limit surface to be engaged with said first limit wall of said ratchet chamber in a first position.

6. A ratchet wrench as claimed in claim 4 wherein said limit member comprising a second limit surface to be engaged with said second limit wall of said ratchet chamber in a second position.

7. A ratchet wrench as claimed in claim 1 wherein said switching unit further comprising a limit slot for a bias member and an elastic to be installed therein.
